(19) United States
(12) Patent Application Publication
(10) Pub. No.: US 2015/0264957 A1
(43) Pub. Date: Sep. 24, 2015

(54) Automated manufacturing process for molded confections

(71) Applicant: Pak NIN Chan, Hong Kong (HK)

(72) Inventor: Pak NIN Chan, Hong Kong (HK)

(21) Appl. No.: 14/660,613

(22) Filed: Mar. 17, 2015

Related U.S. Application Data
(60) Provisional application No. 61/954,748, filed on Mar. 18, 2014.

(51) Int. Cl. A23G 3/34

(52) U.S. Cl. CPC A23G 3/0053

(57) ABSTRACT

An automated process for manufacturing molded confections featuring a three-dimensional molded snack production process in a compact, non-starch and automated fashion. The process for molded confections are steps comprising transfer; selecting mold sets for a desired production sequence; loading the molds onto the assembly system; performing a mold release application; in parallel, preparing the ingredients; pumping the prepared ingredients; depositing ingredients into the mold; transferring the mold assemblies to a forming room; inverting the mold assembly; de-molding and dropping the molded confections candy to a transfer belt conveyor; inverting the mold assembly and returning it to a mold release or a new mold insertion step; sending molded confections product to a transfer and collection means; sending the collected molded confection product to a curing room; holding the product in a surge means; sending product to a package and label; and finally sending the product for shipping and distribution.

### CROSS-REFERENCE TO RELATED APPLICATIONS

This application claims the benefit of U.S. Provisional Patent Application with Ser. No. 61/954,748 filed Mar. 18, 2014 by PAK NIN CHAN and entitled “A unique automated manufacturing process for molded confections”.

### FIELD OF INVENTION

This invention relates to a unique automated manufacturing process for manufacturing molded confections. Traditionally processes for manufacturing molded confections-sweets, including but not limited to those known as gummy snacks (hereinafter the term gummy or gelatin snacks or candies) or lollipops or jelly beans, or the like, are known in the food industry [it is traditional for the gel confections to be typically manufactured by a starch mold casting process known in the trade as the Mogul system]; however, none of the existing procedures allow for the starch-less production of three-dimensional gummy snacks in a compact, non-starch and automated fashion. Likewise, the majority of the conventional processes use starch beds as molds that are stamped to form cavities with the shapes of the gummy snacks that are desired; nevertheless, these shapes are not perfect because the material used does not allow any detail in the formation of the cavities. This new process described herein eliminates the starch and inconsistencies to provide a controllable and repeatable process for providing the three dimensional (3-D) candies. Therefore, there is a need to develop an efficient technology to produce three dimensional (3-D) molded confections that eliminates the disadvantages of the known starch (Mogul) and labor intensive processes and furthermore makes it possible to obtain three-dimensional (3-D) molded confections snacks in a total cost efficient basis.

### FEDERALLY SPONSORED RESEARCH

None.

### SEQUENCE LISTING OR PROGRAM

None.

### BACKGROUND

### Field of Invention and Prior Art

As far as known, there are no special automated manufacturing process for molded confections or the like. It is believed that this process is unique in its design and technologies.

Prior art includes a U.S. Pat. No. 8,409,650 issued Apr. 2, 2013 to Pedro Pasini Bertran called a PROCEDURE AND SHAPING DEVICE FOR PRODUCING THREE-DIMENSIONAL CANDIES. It relates to an innovative procedure for producing three-dimensional candies, preferably of the type known in the food industry as gummy snacks, which eliminates the stamping of starch beds and the cleaning process of the chilled product, furthermore having control of detail on all sides of the product, as well as a transparency and crystallinity never before achieved with the procedures known and traditionally used in the food industry. Likewise, the invention incorporates a completely novel shaping device consisting of two plates connected by a male-female system and with a plurality of product-shaping cavities that are in contact with all sides of the product to be formed. A U.S. Patent Application 2011/0313055 2011 was submitted Ervin called a HEALTH CHARACTERISTIC CHEWY OR GUMMY CANDY CONFECTION. It purports to provide for flavored chewy or gummy candy confections made by making a flavored chewy or gummy candy confection from scratch or adjusting a current flavored chewy or gummy candy confection brand product with our invention. This invention can have a healthier group of edible oils component, unique antioxidant taste profile component, fiber component, water component, emulsifier component, and potentially a 0% or greater supplement component that can add additional dietary benefits. Specific ratios of ingredients can lower sugar content up to 75% while creating a product with a taste, texture, and mouth feel similar to regular flavored chewy or gummy candy. The reduction of sugar possible within this invention can reduce the negative health ramifications of high sugar content that current flavored chewy or gummy candy confections suffer from and the addition of the healthier ingredients adds some improved health characteristics to the products that usually are devoid of nutrition. Additionally, the method for preparing a flavored chewy or gummy candy confection with these improved health characteristics, taste profile, and dietary benefits are covered.

Another a U.S. Pat. No. 3,218,177 was issued in 1965 to Brock et al called a Method for the production of starch base jelly candy. It shows a method where a new starch-base jelly candies and a method for their preparation. More particularly, our invention relates to new starch-base jelly candy cooking mixtures from which improved starch-base jelly candies can be obtained, and to an improved method for producing these starch-base jelly candies utilizing a composition containing a high percentage of amylose. Another U.S. Pat. No. 3,582,349 issued in 1971 to Rasmusson was called an automated forming of non-refrigerated molded food products. This was a non-refrigerated food products formed by feeding a conglomerate food mix in plastic state to the molds of an automated molding equipment of a type conventionally used to form frozen confections. The food mix is characterized by an essentially solid state at room temperature and a plastic state when heated above about body temperature. The mix typically includes as basic ingredients fragile, particulated food solids and an uncooked binding agent. Feeding of the mix to the equipment molds is by nondestructively injecting measured amounts of the mix through nozzle means cyclically reciprocated into and withdrawn from the molds. After solidification of the molded products by rapid cooling of the molds, the molds are briefly heated and the products withdrawn from the molds. If desired, the formed products while still cold can be provided with a high gloss dip coating.

Next a U.S. Pat. No. 4,704,293 was issued in 1987 to Moore et al. called Gel Confections. It is a process for preparing a gel confection comprises: (a) heating a first component comprising sugar, water, and a first gelling agent under conditions which activate the first gelling agent; (b) preparing a second component comprising a second gelling agent which is a granular, non-refrigerent cold-water-swelling starch under conditions which prevent activation of the second gelling agent; (c) mixing the first component and the second component under conditions which activate the second gelling agent; (d) obtaining the desired mixture viscosity for forming; and (e) forming the mixture into the desired shape. A further U.S. Pat. No. 4,744,997 issued in 1986 to Hoffman called a method for producing gum candy. It revealed a gum candy made from a basic sugar-gelatin mass is produced by either preparing the basic mass, if required with the addition of additives, in an injection molding machine and injecting (molding) it immediately subsequent to preparation or preparing the basic mass in conventional boiling apparatuses and molding it with the aid of an injection molding machine, in both cases with the final water content.

A U.S. Pat. No. 4,988,531 issued in 1991 to Moore et al. for a method for manufacturing gel pieces. Here a method of manufacturing gel pieces is provided. The gel pieces are prepared from a cooked mixture comprising a thin-boiling starch as a gelling agent and a sweetener system comprising a high fructose corn syrup and a crystalline sweetener comprised of fructose. The cooked mixture is deposited in a plurality of molds and allowed to set to yield gel pieces which can then be packaged in bulk. The use of high fructose corn syrup and a crystalline fructose sweetener yields gel pieces which have excellent resistance to adhesion to hard surface molds and/or one another when packaged in bulk even over a long period of time at elevated storage temperatures. Another a U.S. Pat. No. 5,242,291 issued in 1993 to Farmakis called a Confection molding machine. This shows a confection molding machine provides for continuous, multiple cavity molding and unmolding of confection figures which may be of differing configuration and mass. The mold device utilizes a self-closing and opening mold in conjunction with dedicated, independent injection nozzles and confection pumps. Two outwardly facing mold halves are carried on an independent mold assembly, and corresponding mold halves abut one another just before filling and again after unmolding the finished confection figure. An endless conveyor, preferably a pair of spaced transfer chains, carries the mold assemblies and the mold halves are clamped together when passing over an unsupported section of the endless conveyor.

A U.S. Pat. No. 6,419,979 issued in 2002 to Nelson et al. called a method for making molded confectionery products. Disclosed was a method for making confectionery products and an apparatus for use in the method. The method involves dissolving confectionery-based ingredients in water to provide a confectionery-based slurry and concentrating the slurry by applying the slurry onto a first hot surface having a first temperature to remove moisture from the slurry, scraping the slurry from the first surface to move the slurry onto a second hot surface having a second temperature to remove additional water from the slurry and provide a concentrated slurry having a final solids content, and scraping the concentrated slurry from the second surface after the desired total solids content is obtained. The concentrated slurry can then be formed into a confectionery product. The method is economical, clean, and may be used to prepare a wide variety of confections. Next, Patent Application 2004/0071831 by Barba called anatomically correct candy novelty demonstrates an anatomically correct candy novelty made of an exterior layer of confectionery material that represents the skin and flesh of an anatomically correct human body part, and an interior layer of hard candy material that represents the skeleton of the same anatomically correct human body part. The exterior layer of confectionery material is made of a soft confectionery material, such as chocolate, a soft, gelatinous gum, taffy, marshmallow, etc. Instead of an anatomically correct human body part, the candy novelty may be formed as a caricature, such as a Frankenstein head, tiger head, etc. The candy novelty may be mounted on a stick.

Another Patent application 2004/0159974 by Fischer is called a method of molding and apparatus. This shows a method of molding and apparatus. The method and apparatus utilize a pin assembly comprising a plurality of pins wherein each pin has a fixed x-coordinate position, a fixed y-coordinate position, and is moveable in a z-coordinate position. A Patent application 2009/0068333 by Muller et al. is called a low temperature mogul method and relates to a novel Mogul procedure for manufacturing sweets, in particular starch-based gummi candies, which have a comparable texture to gelatin-based gummi candies, with at least one portion of the starch not being completely dissolved until after the pouring into the form of the confection article. In comparison to previous Mogul technology, the casting mass is poured at a comparatively low temperature, and the gelling and/or settling occurs at a comparatively high temperature.

A Patent application 2010/0266744 by Dwivedi was called an all natural fruit snack and method of manufacturing and method of manufacturing an all-natural fruit snack. Here a fruit snack was manufactured, in summary, by removing moisture from commercially available juice concentrates (e.g., containing about 30% moisture) by heating for a short time the juice concentrate and vacuuming away excess moisture to produce a fruit juice concentrate with about a 15 to 20% moisture content, mixing the reduced moisture content fruit juice concentrate with fruit purees and gelling agents, preferably both pectin and gelatin, to produce a cooked mass, and depositing the cooked mass in a Mogul machine to produce the molded fruit snack.

### SUMMARY OF THE INVENTION

This invention is a unique automated manufacturing process for molded confections. Taught here are the ways an automated, three dimensional and low labor process can be used to manufacture molded confections in a very efficient manner.

The preferred embodiment of the unique automated manufacturing process for molded confections is comprised of: (1)transfer steps and various sequential steps between the distinct steps, (2) select the mold or mold sets for the desired production sequence, (3) load the selected molds onto the assembly system and thereby establish a mold housing assembly made of the several molds, (4) then perform a mold release application which includes a release means inside a ventilation system; (5) meanwhile or in a parallel manner, prepare the ingredients (Sucrose, Gelatin, Corn Syrup, Flavors and colors. Other ingredients such as fructose, dextrose, artificial/low-calorie sweetener, rice syrup, pectin, modified starch, dextrin, fruit pulp/juice, dairy ingredients including milk and whey, egg white, nut/nut paste, fat/oil, vitamins/nutraceuticals, etc. which may be included or substituted.) which are mixed and stored; (6) pump the ingredients by a pump; (7) deposit ingredients into the mold; (8) transfer the mold assembles to a forming room; (9) invert mold assembly; (10) Clearing/de-molding step that removes the product and the molded confection drops to a transfer belt conveyor or equal; (11) next Re-invert mold assembly and mold assembly returns for re-use to load or direct to mold release application; (12) then send molded confections product to a transfer and collection means; (13) next send the collected molded confections product to a curing room; (14) next transfer to a surge means; (15) next send to a package and label; and finally (16) send to a box, pallet and label for shipping and distribution.

### OBJECTS AND ADVANTAGES

There are several objects and advantages of the unique automated manufacturing process for molded confections. There are currently no known molded confections producing systems or processes that are effective at providing the objects of this invention.

The unique automated manufacturing process for molded confections have the following advantages:

### Advantages and Benefits

| Item | Advantages |
|---|---|
| 1 | Reduced direct labor |
| 2 | Starch-less mold process |
| 3 | Tooling investment cost compared to other starch- |
| | less molding moguls is more competitive. The use |
| | of separate forming room and curing room allows |
| | for less molds needed for the entire process. |
| 4 | Other process improvements: Type of molds, |
| | better formation of product, repeatable process, |
| | unique shapes, 3-D shapes, multi-color and |
| | flavors molded simultaneously, (inject different |
| | mold ports or different molds with different |
| | colors/flavors) so there is an automatics mix at |
| | packaging. |
| 5 | Multiple colors/no mixing is all in the set-up |
| | of depositors. |
| 6 | Reduce overall processing time by reducing |
| | holding time for candy curing and thus overall |
| | in-process inventory also |
| 7 | Cleanliness |
| 8 | Reduced total costs |
| 9 | Reduced processing floor space |

Finally, other advantages and additional features of the present unique automated manufacturing process for molded confections will be more apparent from the accompanying drawings and from the full description of the process. For one skilled in the art of molded confections and the methods and processes to produce, it is readily understood that the features shown in the examples with this process are readily adapted to other types of molded confections processes and systems.

### DESCRIPTION OF THE DRAWINGS

### Figures

The accompanying drawings, which are incorporated in and constitute a part of this specification, illustrate an embodiment of the unique automated manufacturing process for molded confections that is preferred. The drawings together with the summary description given above and a detailed description given below serve to explain the principles of the unique automated manufacturing process for molded confections. It is understood, however, that the unique automated manufacturing process for molded confections is not limited to only the precise arrangements and instrumentalities shown.

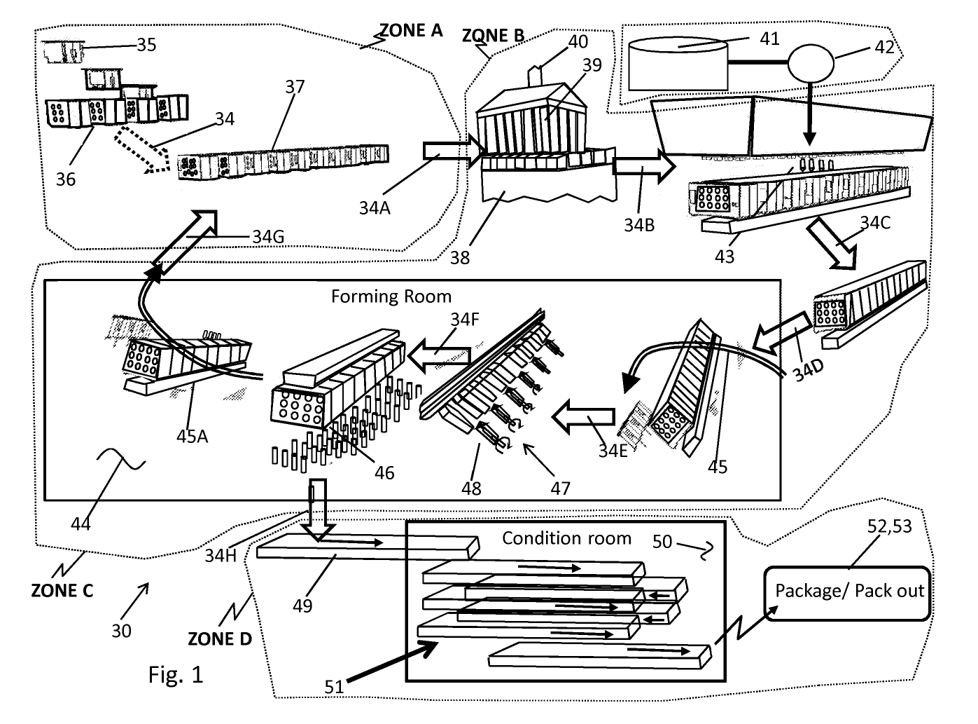

FIG. 1 is a sketch of the unique automated manufacturing process for molded confections.

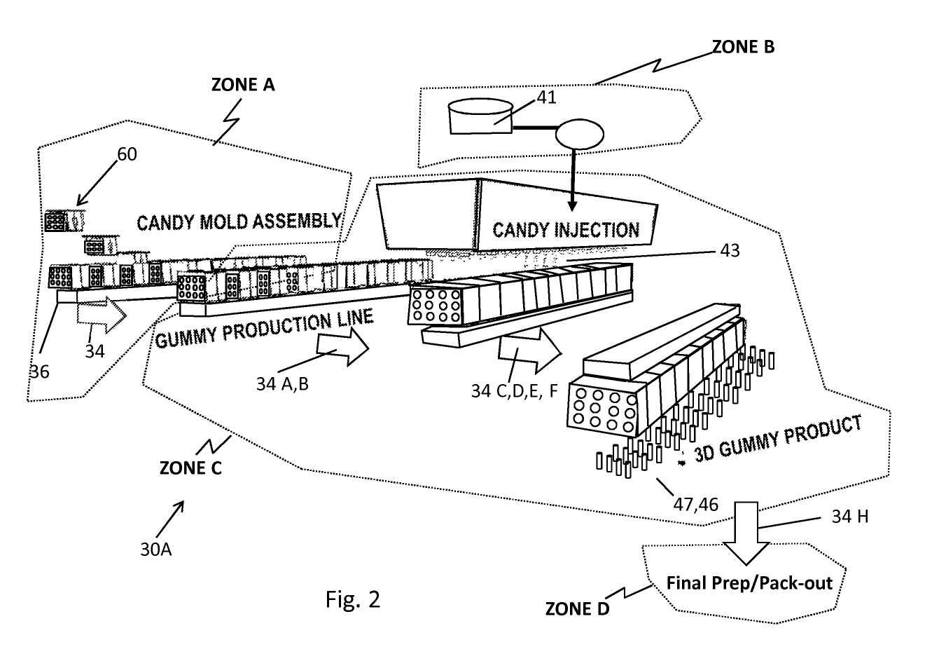

FIG. 2 is a sketch of the unique molded confections process without forming and curing rooms shown.

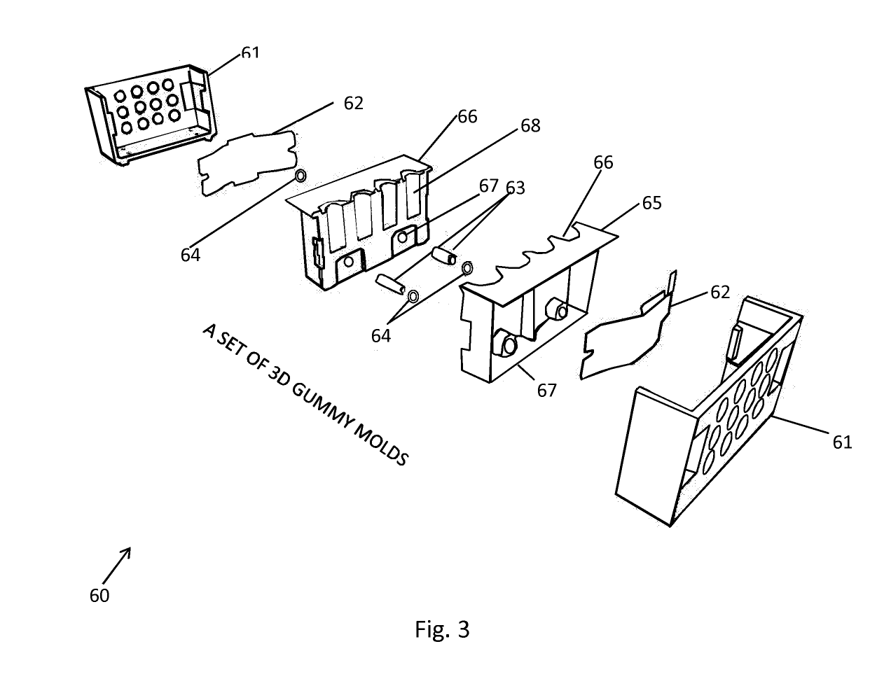

FIG. 3 is a sketch of the unique mold system that is utilized for the process shown.

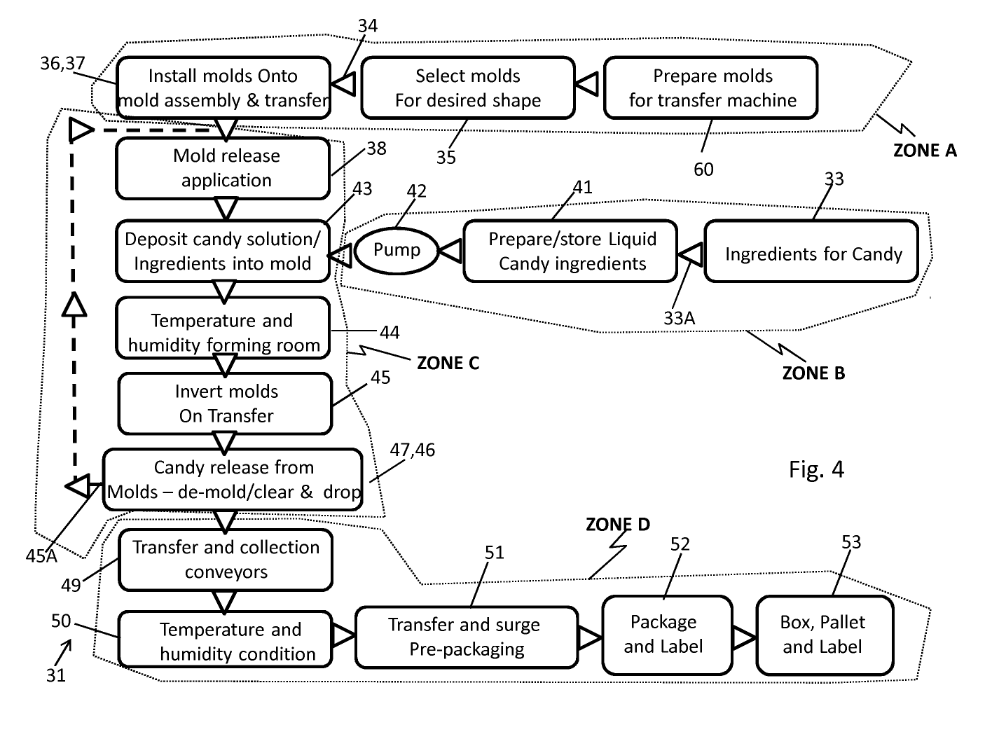

FIG. 4 is a process flow chart of the automated molded confections process.

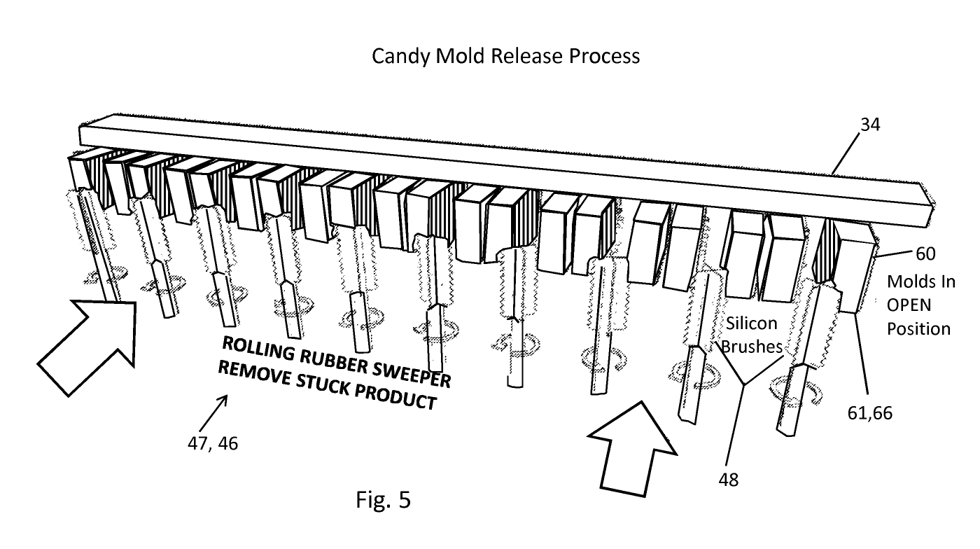

FIG. 5 is a sketch of the mold clearing/de-molding mechanism (rotating brushes, spatula or the like) process in the automated molded confections process.

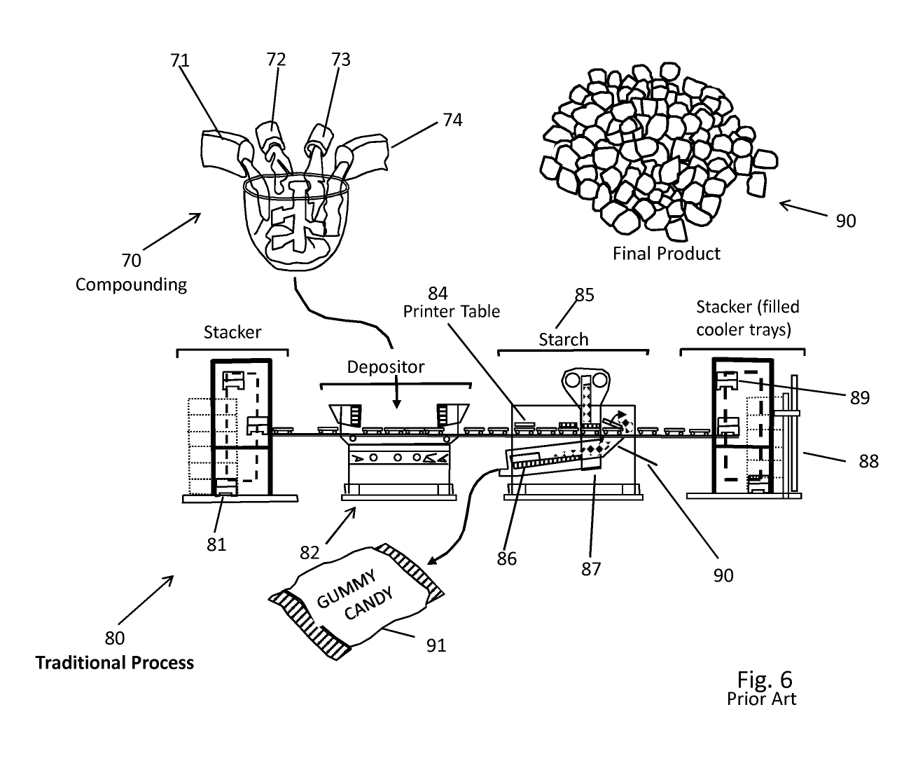

FIG. 6 is a reference sketch of a non automated, traditional starch (Mogul) candy process.

### DESCRIPTION OF THE DRAWINGS

### Reference Numerals

The following list refers to the drawing reference numbers.

| Ref # | Description |
|---|---|
| Zone A | Mold preparation - repair, change out of product types, etc. |
| Zone B | Ingredient preparation, mix and pump |
| Zone C | Production of main 3-D confection product |
| Zone D | Finish product, prepare and pack-out |
| 30 | Unique “automated process” for making starch-less molded |
| | confections |
| 30A | Unique process without forming and curing rooms |
| 31 | Unique flowchart of automated process |
| 33 | Ingredients - Sucrose, Gelatin, Corn Syrup, Flavors and |
| | colors |
| 33A | Means to transfer to mix tank 41 |
| 34 | Transfer steps - various A through G |
| 35 | Select mold |
| 36 | Load mold onto assembly |
| 37 | Mold housing assembly |
| 38 | Mold release application |
| 39 | Release means (spray, mist, liquid, etc) |
| 40 | Ventilation system (enclosure and duct fan) |
| 41 | Ingredients mix and store |
| 42 | Ingredients pump |
| 43 | Deposit ingredients into molds |
| 44 | Forming room (temperature and humidity control) |
| 45 | Invert mold assembly [conveyor, walking beam, pick and place |
| | etc. presented as examples and not as limitations] |
| 45A | Invert mold assembly 45A - return for re-use to load 36 or |
| | direct to mold release application 38 |
| 46 | Drop candy to transfer conveyor belt or equal |
| 47 | De-mold and Clear mold cavities |
| 48 | Clearing/de-molding mechanism (rotating brushes, spatula or |
| | the like) |
| 49 | Transfer and collection means (conveyors, vibrating tables, |
| | etc.) |
| 50 | Curing room (temperature and humidity control) |
| 51 | Transfer and surge means (conveyors, etc.) |
| 52 | Package and label |
| 53 | Box, Pallet and label |
| 60 | Prepare mold |
| 61 | Mold housing |
| 62 | Retaining plate |
| 63 | Clean pins |
| 64 | Ring |
| 65 | Mold castings (3-D, various formation) |
| 66 | Depositing port |
| 67 | Casting aperture |
| 68 | 3D recess (figures or characters or shapes of the ultimate |
| | desired molded confections) |
| 70 | Compounding gumming ingredients |
| 71 | Sucrose |
| 72 | Glucose |
| 73 | Corn syrup |
| 74 | Flavors |
| 80 | Traditional (Mogul) non-automated gummy manufacturing |
| | process |
| 81 | Stacker |
| 82 | Depositor |
| 84 | Printer table |
| 85 | Starch bank machine |
| 86 | Rotary brush |
| 87 | Rotary Sieve |
| 88 | Stacker filled with cooler trays |
| 89 | Trays |
| 90 | Final product |
| 91 | Package and skid to suit |

### DETAILED DESCRIPTION OF PREFERRED EMBODIMENT

The present development is a unique automated manufacturing process for molded confections. This invention relates to a Special automated manufacturing process for manufacturing molded confections. Traditionally processes for manufacturing sweets, including those known as molded confections-sweets, including but not limited to those known as gummy snacks (hereinafter the term gummy or gelatin snacks or candies) or lollipops or jelly beans, or the like, are known in the food industry; however, none of the existing procedures allow for the production of three-dimensional molded confections in a compact, non-starch and automated fashion. Likewise, the majority of the conventional processes use starch beds as molds that are stamped to form cavities with the shapes of the gummy snacks that are desired; nevertheless, these shapes are not perfect because the material used does not allow any detail in the formation of the cavities. This new process eliminates the starch and inconsistencies to provide a controllable and repeatable process for providing the three dimensional (3-D) candies. Therefore, there is a need to develop an efficient technology to produce three dimensional (3-D) molded confections that eliminates the disadvantages of the known starch and labor intensive processes and furthermore makes it possible to obtain three-dimensional (3-D) molded confections in a total cost efficient basis.

The advantages for the unique automated manufacturing process for molded confections are listed above in the introduction. Succinctly the benefits are that the device:
A. Reduced direct labor.
B. Starch-less mold process.
C. Tooling investment cost compared to other starch-less molding moguls is more competitive. The use of separate forming room and curing room allows for less molds needed for the entire process.
D. Other process improvements: Type of molds, better formation of product, repeatable process, unique shapes, 3-D shapes, multi-color and flavors molded simultaneously, (inject different mold ports or different molds with different colors/flavors) so there is an automatics mix at packaging.
E. Multiple colors/no mixing is all in the set-up of depositors.
F. Reduce overall processing time by reducing holding time for candy curing and thus overall in-process inventory.
G. Cleanliness.
H. Reduced total costs.
I. Reduced processing floor space.

The preferred embodiment of the unique automated manufacturing process for molded confections is comprised of: (1)transfer steps and various sequential steps between the distinct steps, (2) select the mold or mold sets for the desired production sequence, (3) load the selected molds onto the assembly system and thereby establish a mold housing assembly made of the several molds, (4) then perform a mold release application which includes a release means inside a ventilation system; (5) meanwhile or in a parallel manner, prepare the ingredients (Sucrose, Gelatin, Corn Syrup, Flavors and colors. Other ingredients such as fructose, dextrose, artificial/low-calorie sweetener, rice syrup, pectin, modified starch, dextrin, fruit pulp/juice, dairy ingredients including milk and whey, egg white, nut/nut paste, fat/oil, vitamins/nutraceuticals, etc. which may be included or substituted.) which are mixed and stored; (6) pump the ingredients by a pump; (7) deposit ingredients into the mold; (8) transfer the mold assembles to a forming room; (9) invert mold assembly; (10) Clearing/de-molding; (11) next Re-invert mold assembly and mold assembly returns for re-use to load or direct to mold release application; (12) then send molded confections product to a transfer and collection means; (13) next send the collected molded confections product to a curing room; (14) next transfer to a surge means; (15) next send to a package and label; and finally (16) send to a box, pallet and label for shipping and distribution. These various steps can be simplified as four (4) distinct zones: Zone A—Mold preparation-repair, change out of product types, etc.; Zone B—Ingredient preparation, mix and pump; Zone C—Production of main 3-D confection product; and Zone D—Finish product, prepare and pack-out.

There are shown in FIGS. 1-6 a complete description and operative embodiment of the unique automated manufacturing process for molded confections. In the drawings and illustrations, one notes well that the FIGS. 1-6 demonstrate the unique configuration and use of this process. The various example uses are in the operation and use section, below.

The accompanying drawings, which are incorporated in and constitute a part of this specification, illustrate an embodiment of the unique automated manufacturing process for molded confections that is preferred. The drawings together with the summary description given above and a detailed description given below serve to explain the principles of the unique automated manufacturing process for molded confections. It is understood, however, that the process is not limited to only the precise arrangements and instrumentalities shown. Other examples of molded confections automated processes and uses are still understood by one skilled in the art of molded confections producing processes to be within the scope and spirit shown here.

FIG. 1 is a sketch of the unique automated manufacturing process for molded confections. These various steps can be simplified as four (4) distinct zones: Zone A —Mold preparation-repair, change out of product types, etc.; Zone B—Ingredient preparation, mix and pump; Zone C—Production of main 3-D confection product; and Zone D—Finish product, prepare and pack-out. Shown and demonstrated are the unique “automated process” 30 for making starch-less molded confections including the (1)transfer steps 34 and various sequential steps between the distinct steps, (2) select the mold 35 or mold sets for the desired production sequence, (3) load 36 the selected molds onto the assembly system and thereby establish a mold housing assembly 37 made of the several molds, (4) then perform a mold release 38 application which includes a release means 39 (spray, mist, liquid, etc.) inside a ventilation system 40 (enclosure and duct fan); (5) meanwhile or in a parallel manner, prepare the ingredients (Sucrose, Gelatin, Corn Syrup, Flavors and colors. Other ingredients such as fructose, dextrose, artificial/low-calorie sweetener, rice syrup, pectin, modified starch, dextrin, fruit pulp/juice, dairy ingredients including milk and whey, egg white, nut/nut paste, fat/oil, vitamins/nutraceuticals, etc. which may be included or substituted.) which are mixed and stored; (6) pump the ingredient by a pump 42; (7) deposit 43 ingredients into the mold apertures 66; (8) transfer the mold assembles to a forming room 44 (temperature and humidity control); (9) invert 45 mold assembly [conveyor, walking beam, pick and place etc. presented as examples and not as limitations]; (10) Clearing/de-molding step 47 with mechanism 48 (rotating brushes, spatula or the like) that removes the product and the molded confection drops 46 to a transfer belt conveyor or equal; (11) next Re-invert mold assembly 45A—mold assembly returns for re-use to load 36 or direct to mold release application 38; (12) then send molded confections product to a transfer and collection means 49 (conveyors, vibrating tables, etc.); (13) next send the collected molded confections product to a curing room 50 (temperature and humidity control); (14) next transfer to a surge means 51 (conveyors, etc.); (15) next to a package and label 52; and finally (16) to a Box, Pallet and label 53 for shipping and distribution.

FIG. 2 is a sketch of the unique molded confections process without forming and curing rooms shown. These various steps can be simplified as four (4) distinct zones: Zone A —Mold preparation-repair, change out of product types, etc.; Zone B—Ingredient preparation, mix and pump; Zone C—Production of main 3-D confection product; and Zone D—Finish product, prepare and pack-out. Shown and demonstrated are the unique “automated process” 30 for making starch-less molded confections including the (1)transfer steps 34 and various sequential steps, (2) select the or a mold 35 or mold sets for the desired production sequence, (3) load 36 the selected molds onto the assembly system and thereby establish a mold housing assembly 37 made of the several molds, (4) then perform a mold release 38 application which includes a release means 39 (spray, mist, liquid, etc.) inside a ventilation system 40 (enclosure and duct fan); (5) meanwhile or in a parallel manner, prepare the ingredients (Sucrose, Gelatin, Corn Syrup, Flavors and colors) which are mixed and stored 41; (6) pump the ingredient by a pump 42; (7) deposit 43 ingredients into the mold apertures 66; (8) transfer the mold assembles to a forming room 44 (temperature and humidity control); (9) invert 45 mold assembly; and (10) drop 46 candy to a transfer belt conveyor or equal. Note the forming, curing and pack out are not shown in this view.

FIG. 3 is a sketch of the unique mold system 60 that is utilized for the process shown. Demonstrated here are the prepare mold 60, mold housing 61, retaining plate 62, clevis pins 63, ring 64, mold castings 65 (3-D, various formation), depositing port 66, casting aperture 67, and three dimensional (3-D) recess 68.

FIG. 4 is a process flow chart of the automated gelatin candy process. Shown as a flow chart are the similar steps from FIG. 1. These various steps can be simplified as four (4) distinct zones: Zone A—Mold preparation-repair, change out of product types, etc.; Zone B—Ingredient preparation, mix and pump; Zone C—Production of main 3-D confection product; and Zone D—Finish product, prepare and pack-out. Shown and demonstrated are the unique “automated process” 30 for making starch-less molded confections including the (1)transfer steps 34 and various sequential steps, (2) select the or a mold 35 or mold sets for the desired production sequence, (3) load 36 the selected molds onto the assembly system and thereby establish a mold housing assembly 37 made of the several molds, (4) then perform a mold release 38 application which includes a release means 39 (spray, mist, liquid, etc.) inside a ventilation system 40 (enclosure and duct fan); (5) meanwhile or in a parallel manner, prepare the ingredients (Sucrose, Gelatin, Corn Syrup, Flavors and colors) which are mixed and stored 41; (6) pump the ingredient by a pump 42; (7) deposit 43 ingredients into the mold apertures 66; (8) transfer the mold assembles to a forming room 44 (temperature and humidity control); (9) invert 45 mold assembly [conveyor, walking beam, pick and place etc. presented as examples and not as limitations]; (10) Clearing/de-molding step 47 with mechanism 48 (rotating brushes, spatula or the like) that removes the product and the molded confection drops 46 to a transfer belt conveyor or equal; (11) next Re-invert mold assembly 45A—mold assembly returns for re-use to load 36 or direct to mold release application 38; (12) then send molded confections product to a transfer and collection means 49 (conveyors, vibrating tables, etc.); (13) next send the collected molded confections product to a curing room 50 (temperature and humidity control); (14) next transfer to a surge means 51 (conveyors, etc.); (15) next to a package and label 52; and finally (16) to a Box, Pallet and label 53 for shipping and distribution.

FIG. 5 is a sketch of the mold clean and sweep process in the automated molded confections candy process. Here is shown the molds 60 with the housing 61 and casting 65, along with the de-molding or clearing mechanism 48—brush, spatula, etc. Once the molded confection is removed from the cavities, the mold assembly is re-inverted 45A and returned for re-use to load 36 or direct to mold release application 38.

FIG. 6 is a reference sketch of a non automated, traditional starch candy process 80. Shown are the Compounding gumming ingredients 70 (including but not limited to sucrose 71, glucose 72, corn syrup 73, and flavors 74), traditional non-automated gummy manufacturing (Mogul) process 80; a stacker 81, a depositor 82, a printer table 83, a starch bank machine 85, a rotary brush 86, a rotary Sieve 87, a stacker filled with cooler trays 88, a set of cooling trays 89, a final product 90, and means to package and skid to suit 91.

The details mentioned here are exemplary and not limiting. Other specific components and manners specific to describing a unique automated manufacturing process for molded confections may be added as a person having ordinary skill in the field of molded confections processes and manufacturing methods and their uses well appreciates.

### OPERATION OF THE PREFERRED EMBODIMENT

The unique automated manufacturing process for molded confections has been described in the above embodiment. The manner of how the process operates is evident from the descriptions above. One notes well that the description above is incorporated as describing the operation. These various steps can be simplified as four (4) distinct zones: Zone A —Mold preparation-repair, change out of product types, etc.; Zone B—Ingredient preparation, mix and pump; Zone C—Production of main 3-D confection product; and Zone D—Finish product, prepare and pack-out. The basic process steps are: (1) select the mold 35 or mold sets for the desired production sequence; (2)transfer steps 34 and various sequential steps; (3) load 36 the selected molds onto the assembly system and thereby establish a mold housing assembly 37 made of the several molds, (4) then perform a mold release 38 application which includes a release means 39 (spray, mist, liquid, etc.) inside a ventilation system 40 (enclosure and duct fan); (5) (5) meanwhile or in a parallel manner, prepare the ingredients (Sucrose, Gelatin, Corn Syrup, Flavors and colors. Other ingredients such as fructose, dextrose, artificial/low-calorie sweetener, rice syrup, pectin, modified starch, dextrin, fruit pulp/juice, dairy ingredients including milk and whey, egg white, nut/nut paste, fat/oil, vitamins/nutraceuticals, etc. which may be included or substituted.) which are mixed and stored; (6) pump the ingredient by a pump 42; (7) deposit 43 ingredients into the mold apertures 66; (8) transfer the mold assembles to a forming room 44 (temperature and humidity control); (9) invert 45 mold assembly [conveyor, walking beam, pick and place etc. presented as examples and not as limitations]; (10) Clearing/de-molding step 47 with mechanism 48 (rotating brushes, spatula or the like) that removes the product and the molded confection drops 46 to a transfer belt conveyor or equal; (11) next Re-invert mold assembly 45A—mold assembly returns for re-use to load 36 or direct to mold release application 38; (12) then send molded confections product to a transfer and collection means 49 (conveyors, vibrating tables, etc.); (13) then send the collected molded confection product to a curing room 50 (temperature and humidity control); (14) next transfer to a surge means 51 (conveyors, etc.); (15) next to a package and label 52; and finally (16) to a Box, Pallet and label 53 for shipping and distribution.

With this description it is to be understood that the unique automated manufacturing process for molded confections is not to be limited to only the disclosed embodiment of product. The features of the unique automated manufacturing process for molded confections are intended to cover various modifications and equivalent arrangements of the production process included within the spirit and scope of the description.

It will be understood that each of the elements described above may also find a useful application in other types of methods differing from the type described above. While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described. All patents and publications mentioned herein, including those cited in the Background of the application, are hereby incorporated by reference to disclose and described the methods and/or materials in connection with which the publications are cited.

The publications discussed herein are provided solely for their disclosure prior to the filing date of the present application. Nothing herein is to be construed as an admission that the present inventions are not entitled to antedate such publication by virtue of prior invention. Further, the dates of publication provided may be different from the actual publication dates which may need to be independently confirmed.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

As used herein, spatial or directional terms, such as “left,” “right,” “front,” “back,” and the like, relate to the subject matter as it is shown in the drawing FIGS. However, it is to be understood that the subject matter described herein may assume various alternative orientations and, accordingly, such terms are not to be considered as limiting. Furthermore, as used herein (i.e., in the claims and the specification), articles such as “the,” “a,” and “an” can connote the singular or plural. Also, as used herein, the word “or” when used without a preceding “either” (or other similar language indicating that “or” is unequivocally meant to be exclusive—e.g., only one of x or y, etc.) shall be interpreted to be inclusive (e.g., “x or y” means one or both x or y). Likewise, as used herein, the term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

What is claimed is:

1. A unique automated manufacturing process for molded confections is comprised of:
Zone A Mold preparation-repair, change out of product types, etc.;
Zone B Ingredient preparation, mix and pump;
Zone C Production of main 3-D confection product; and
Zone D Finish product, prepare and pack-out.

2. The process in claim 1 wherein the Zone A is further comprised of:
Step 1: selecting a mold (35) or mold sets for the desired production sequence;
Step 2: loading (36) the selected molds onto the assembly system and thereby establish a mold housing assembly 37 made of the several molds; and
Step 3: transferring steps (34) and various sequential steps

3. The process in claim 1 wherein the Zone B is further comprised of:
Step 5: preparing the ingredients (41) which are mixed and stored;
Step 6: pumping the ingredient by a pump (42); and
Step 7: depositing (43) ingredients into the mold apertures (66);

4. The process in claim 1 wherein the Zone C is further comprised of:
Step 8: transferring the mold assembles to a forming room (44);
Step 9: inverting (45) mold assembly;
Step 10: Clearing/de-molding step (47) with mechanism (48) that removes the product and the molded confection drops (46) to a transfer belt conveyor or equal; and
Step 11: re-inverting mold assembly (45A) and mold assembly returns for re-use to load (36) or direct to mold release application (38);

5. The process in claim 1 wherein the Zone D is further comprised of:
Step 12: sending molded confections product to a transfer and collection means (49);
Step 13: sending the collected molded confections product to a curing room (50);
Step 14: transferring to a surge means (51);
Step 15: packaging and labeling (52); and
Step 16 transferring to a box, pallet and label (53) for shipping and distribution.

6. A unique automated manufacturing process for molded confections is comprised of:
Step 1: selecting a mold (35) or mold sets for the desired production sequence;
Step 2: loading (36) the selected molds onto the assembly system and thereby establish a mold housing assembly 37 made of the several molds;
Step 3: transferring steps (34) and various sequential steps;
Step 4: performing a mold release (38) application which includes a release means (39) inside a ventilation system (40);
Step 5: in a parallel manner, preparing the ingredients (41) which are mixed and stored;
Step 6: pumping the ingredient by a pump (42);
Step 7: depositing (43) ingredients into the mold apertures (66);
Step 8: transferring the mold assembles to a forming room (44);
Step 9: inverting (45) mold assembly;
Step 10: Clearing/de-molding step (47) with mechanism (48) that removes the product and the molded confection drops (46) to a transfer belt conveyor or equal;
Step 11: re-inverting mold assembly (45A) and mold assembly returns for re-use to load (36) or direct to mold release application (38);
Step 12: sending molded confections product to a transfer and collection means (49);
Step 13: sending the collected molded confections product to a curing room (50);
Step 14: transferring to a surge means (51);
Step 15: packaging and labeling (52); and
Step 16 transferring to a box, pallet and label (53) for shipping and distribution.

7. The process in claim 6 wherein the release means (39) is selected from the group consisting of a spray, a mist, and a liquid applicator.

8. The process in claim 6 wherein the ventilation system (40) is further comprised of an enclosure and a duct fan.

9. The process in claim 6 wherein the ingredients are selected from a group consisting of Sucrose, Gelatin, Corn Syrup, Flavors and colors, fructose, dextrose, artificial/low-calorie sweetener, rice syrup, pectin, modified starch, dextrin, fruit pulp/juice, dairy ingredients including milk and whey, egg white, nut/nut paste, fat/oil, vitamins/and nutraceuticals.

10. The process in claim 6 wherein the forming room (44) has temperature and humidity control.

11. The process in claim 6 wherein the inverting (45) mold assembly is selected from a group consisting of a conveyor, a walking beam, and a pick and place system.

12. The process in claim 6 wherein the collection means (49) is selected from a group consisting of conveyors and vibrating tables.

13. The process in claim 6 wherein the curing room (50) has temperature and humidity control.
